(19) United States
(12) Patent Application Publication
(10) Pub. No.: US 2023/0274174 A1
(43) Pub. Date: Aug. 31, 2023

(54) MINIATURE ION TRAPS FOR FAST, HIGH-FIDELITY AND SCALABLE QUANTUM COMPUTATIONS

(71) Applicants: THE REGENTS OF THE UNIVERSITY OF CALIFORNIA, Oakland, CA (US); LAWRENCE LIVERMORE NATIONAL SECURITY, LLC, Livermore, CA (US)

(72) Inventors: JUERGEN BIENER, Castro Valley, CA (US); HARTMUT HAEFFNER, Berkeley, CA (US); CLEMENS MATTHIESEN, Cambridge (GB); ELI MEGIDISH, Albany, CA (US); JAMES SPENCER OAKDALE, Castro Valley, CA (US); XIAOXING XIA, Pleasanton, CA (US)

(21) Appl. No.: 18/005,393

(22) PCT Filed: Jul. 14, 2021
(86) PCT No.: PCT/US21/41530

§ 371 Date: Jan. 13, 2023

Related U.S. Application Data
(60) Provisional application No. 63/051,671, filed on Jul. 14, 2020.

(51) Int. Cl. G06N 10/40

(52) U.S. Cl. CPC G06N 10/40

(57) ABSTRACT

A vertical ion trap include at least four RF electrodes on a substrate, the RF electrodes extending up from the substrate, a region between the electrodes forming the vertical ion trap, and at least two direct current electrodes adjacent the RF electrodes and the vertical ion trap. A horizontal ion traps includes a substrate, the substrate having a hole, at least one RF electrodes raised above the substrate and offset from each other across the hole, the RF electrodes, and at least one DC electrode corresponding to each RF electrode, the DC electrodes raised above the substrate. A method of forming an ion trap includes forming three-dimensional structures on a substrate in a curable polymer using two-photon polymerization direct laser writing, metalizing the three-dimensional structures to form RF electrodes, and forming direct current electrodes at least partially on the substrate.

### CROSS REFERENCE TO RELATED APPLICATIONS

This application is a 371 of International Application No. PCT/US2021/041530 filed Jul. 14, 2021, which claims priority to and the benefit of U.S. Provisional Application No. 63/051,671 filed Jul. 14, 2020, which are incorporated herein by reference in their entirety.

### TECHNICAL FIELD

This disclosure relates to ion traps, more particularly to ion traps manufactured using three-dimensional printing.

### BACKGROUND

Quantum information processing (QIP), based upon quantum computing, uses quantum-mechanical phenomena such as superposition and entanglement to perform computation. Quantum circuits use quantum bits, or qubits. Qubits are stored in stable electronic states of each ion, and quantum information can transfer through the collective quantized motion of the ions in a shared trap.

Scalable architectures for quantum information processing with trapped ions will necessarily comprise thousands of computation sites. Each computational site would house several ions, which serve as qubits. In a CCD-like architecture, additional electrodes are splitting, merging and transporting ions to different loading, manipulation and readout zones. Laser or microwave radiation addresses the ion's coherently controlling the electronic and or motional quantum state to perform computing. Currently pursued large-scale architectures rely on two-dimensional trap geometries amenable to lithographic microfabrication. This method raises challenges when scaling to a large number of computation sites.

The price for being compatible with these scalable fabrication methods is of a reduced confinement of ions in the trap, reflected by lower secular frequencies as compared to three-dimensional electrode arrangements. Ions do not oscillate at the fundamental frequency applied to the trap. Ions radiate at a secular frequency, lower than the fundamental frequency. To compensate for the reduced confinement, these microfabricated planar traps tend to be smaller such that reasonable voltages can achieve acceptable secular frequencies. Small ion-electrode distances increase the speed of splitting, merging and transporting ion crystals required for the CCD-architecture, as well as the ability to apply large microwave gradients for laser-free gates. However, this proximity of the ion to the electrode surfaces leads to decoherence, limiting the fidelity of multiple-qubit gates and in many instances also single-qubit gates.

Planar geometries also reduce the trap depth by more than one order of magnitude as compared to a 3D arrangement. This reduced trap depth decreases the storage time of the ions substantially.

Microfabrication methods are well established in the semiconductor industry where an approximately ten-nanometer process control is required. To achieve this, the industry has developed fine control tools to monitor and regulate the different processes. Trapped ions require control on the micrometer scale. Further microfabrication methods focus on mass fabrication of thousands or millions of devices, not single prototypes as required for the rapid development of ion trap technology.

### BRIEF DESCRIPTION OF THE DRAWINGS

FIG. 1 shows an embodiment of RF printed electrodes on a PCB.

FIG. 2 shows a 3D rendering of an embodiment of an array of traps.

FIG. 3 shows an embodiment of electrodes on a substrate.

FIG. 4 shows a scanning electrode microscope image

FIG. 5 shows an embodiment of a horizontal trap design.

FIG. 6 shows an embodiment of scalable ion-trap QIP-architecture.

FIG. 7 shows a scanning electrode microscope image of RF and DC electrodes on a PCB.

FIG. 8 shows a diagram of electrical connections for RF and DC electrodes on a PCB.

### DETAILED DESCRIPTION OF THE EMBODIMENTS

The embodiments propose a new method for trap fabrication that allows one to fabricate 2D and 3D trap geometries with submicron precision. For trap fabrication, the process exploits two-photon polymerization direct laser writing (2PP-DLW). This technique relies on a focused, femtosecond pulsed laser to drive local polymerization chemistries within 2PP-responsive photoresists, such as curable epoxies or acrylics. Deterministically scanning the laser through the photoresist forms 3D structures, either by translation of the substrate around a stationary beam or by scanning the laser around a stationary substrate. A combination of scanning galvo-mirrors, piezo stages and linear x/y motor stages enables fabrication of complex, millimeter-sized freestanding 3D structures with an ultimate resolution of approximately 100 nanometers, allowing mask-free fabrication of complex 3D electrode designs with 10-50 micrometer spacing with submicron resolution.

In the second stage, the process coats the desired electrode structure with the material of choice. The process may utilize different coating methods including sputter coating and even electroplating to reach a micron-width metalization. The proposed method consists of only two steps leading to a fast, reliable and cost-efficient fabrication process. In the development stage, it allows for a faster and easier optimization of the trap parameters such as electrode sizes or geometry.

Using this method, the process can fabricate any 2D structures currently fabricated via the expensive microfabrication methods, but a major advantage of the proposed method is the ability to fabricate segmented and complex 3D traps. Miniature 3D traps allow for secular frequencies about a factor of three to six higher as compared to similarly sized planar traps. This speeds up quantum operations and increases resilience to electric-field noise. In addition, the 3D geometry increases trap depths by up to two-orders of magnitude thereby reducing the ion loss. The flexible electrode arrangement also allows for high optical access allowing for high fidelity single and multi-qubit gates and high fidelity readout.

The unique ability of this method to create segmented 3D traps with micrometer-sized features enables shuttling of ions in all three spatial dimensions. As a result, this fabrication method provides a promising path for scalable trapped ion quantum computation.

The printing process could print on different substrates such as glass, plastic and ceramics enabling a direct printing on circuit boards or ceramic chip carriers. Furthermore, in addition to the electrode structure one can print electrical wires and trenches to establish a direct electrical connection to pads on the surface. This feature allows circumventing the use of wire bonding currently used to connect the electrode structure to breakout boards. The process could implement shadow asking technique to isolate electrically the wiring for each electrode DC or RF to the designated pad on the board.

Additionally, one expects that fabrication of 3D-electrode structures will open up the possibility to use electrons instead of ions as qubits. Due to their reduced mass, electrons may lead to vastly increased speed of quantum gates as compared to trapped ions. However, because of the lack of opportunities to perform laser cooling one should expect that sufficient trap depth and harmonicity of the trapping potentials are critical in this endeavor. 3D-geometries will be key to achieve large trap depth and trap harmonicity.

Given the trapping parameters and geometry, an optimized trap is designed. Given the printing constraints one should optimize the mechanical support, electrical connection and wiring to the different electrodes. The trap is constructed from a UHV compatible plastic using two-photon polymerization direct laser writing (2PPDLW). This process relies on a tightly focused, femtosecond pulsed laser to drive local polymerization chemistry within 2PP-responsive photoresists. The ultra-short laser pulses polymerize photosensitive materials in the laser focus via two-photon absorption. The cross-linking of the polymer chains renders the exposed volume insoluble relative to its unexposed environment. The process washes the unexposed polymer in a developer bath; the exposed regions remain as self-supporting 3D nano- and micro-meter scale structures. The process then coats the structures with metal, either by electroplating, dip coating, etc. In one embodiment, the metal comprises gold.

The above process may have many different variations. No limit exists on the trap geometries, structures or interconnects. The process could use different metal coatings, combinations of different metals, different types of curable polymers, etc.

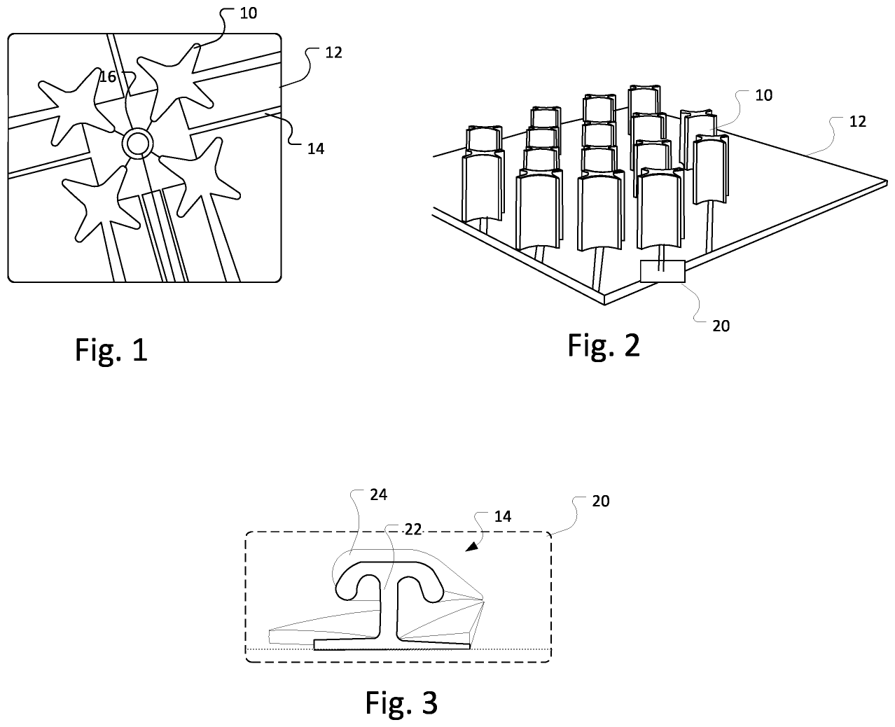

FIG. 1 shows a top view of an embodiment of RF electrodes 10 on a printed circuit board (PCB) 12. Direct current (DC) 14 electrodes for vertical confinement exist on the PCB adjacent the RF electrodes. The radio frequency on opposing electrodes would be at the same phase with a phase shift of π between pairs. The DC 14 adjacent under the RF electrodes 10 provide confinement in the out-of-plane. The traps lie between the electrodes in the region such as 16. In general, the DC electrodes will operate in a range of voltages from 5 to 40 volts. For many embodiments, 10 volts will suffice. The RF electrodes may operate at wide ranges of frequency and amplitude. In one embodiment, the RF electrodes operate at about 100 volts of amplitude, with a frequency of 100 MHz.

FIG. 2 shows a 3D rendering of an array of traps such as those shown in FIG. 1 between the RF electrodes such as 10, on the substrate 12, which may or may not include a ground plane. Each set of four electrodes in the array form the ion traps.

FIG. 3 shows a blown up view of the region 20 from FIG. 2. During manufacture, a shadow mask on the electrodes prevents the coating 24 from reaching some of the 3D printed material. This creates the necessary electrical disconnect between traces and electrodes on the substrate. Alternatively, the electrode pattern can be defined with a photoresist before the vertical electrodes are printed on the substrate. The subsequent sputter-coating will thus directly create the desired electrode features on the substrate, electrically isolate

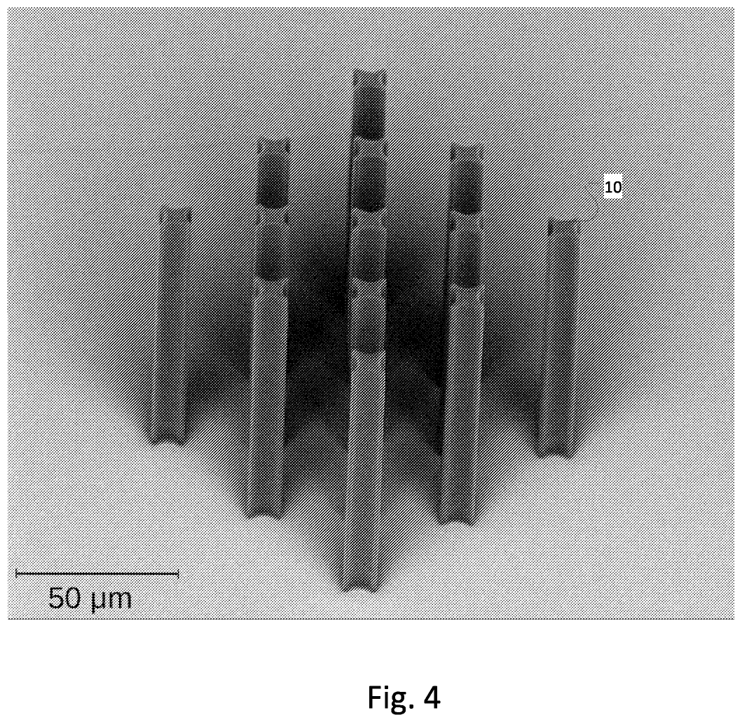

FIG. 4 shows a scanning electron microscope image of the RF electrodes 10 manufactured during an experiment. The image shows that the process can manufacture 10-μm wide and structures having a vertical extent of 100-μm tall structures accurately. The whole procedure from creating the model, to printing and taking the SEM-image took less than three hours for this experiment.

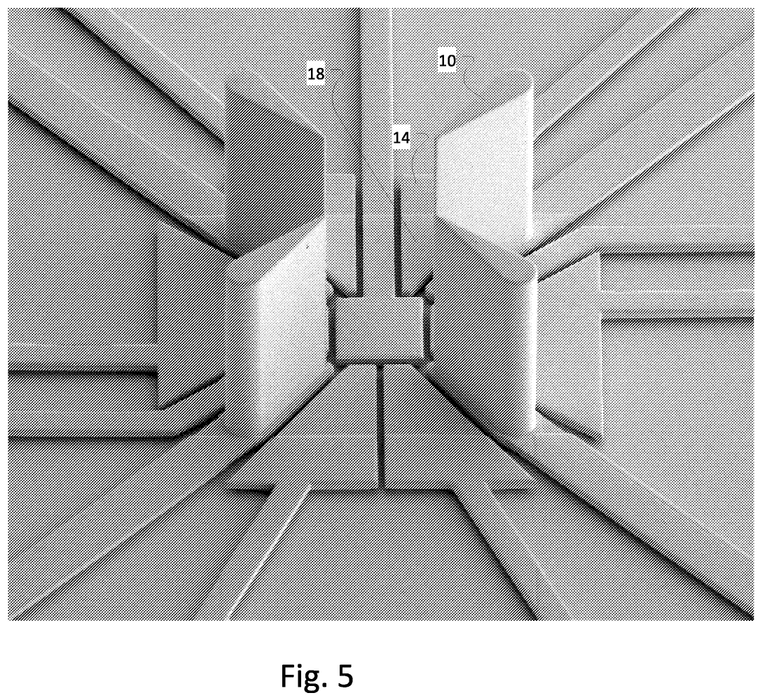

FIG. 5 shows a scanning electron microscope of another embodiment of a structure of RF electrodes 10 and DC electrodes 14 and 18 on the substrate as manufactured in accordance with the embodiments. The gaps between the electrodes allow for electrical separation between the various structures. All of the electrodes on the substrate, referred to here as being ‘in-plane’ are DC electrodes. The electrodes, such as 10, extend vertically from the substrate out-of-plane.

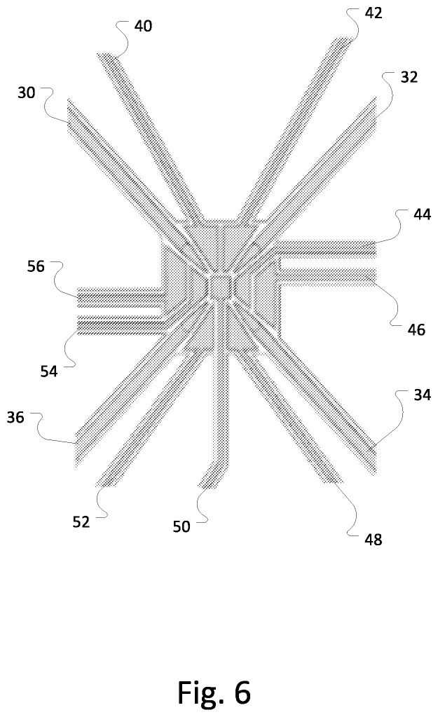

FIG. 6 shows a top-view of the substrate and the in-plane electrodes. The RF electrodes 30, 32, 34 and 36 normally have the extrusions for the RF electrodes and provide the electrical connections RF electrodes. The remaining electrodes are all DC electrodes. Electrodes 40, 42, 48, and 52 have a single segment architecture. Electrodes 44/46 and 54/46 form segmented electrodes. The center electrode 50 is also a DC electrode. Generally, the DC electrodes surround the RF electrodes, but remain in-plane.

The presence of multiple DC electrodes in any of the embodiments allows very precise control of the potential. For example, one can determine where the minimum is in space, requiring three degrees-of-freedom, and then set all five curvatures, which requires five more degrees-of-freedom.

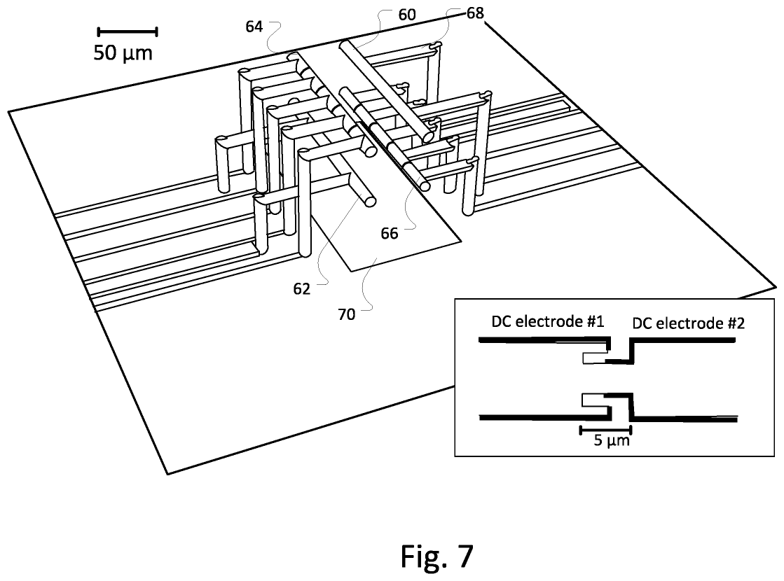

In addition to the vertical design, the process can manufacture horizontal traps as shown in FIG. 7. The trap consists of two RF electrodes rods 60 and 62 opposing each other and two rods with short DC-segments 64 and 66 separated by a few micrometers from each other, typically between 5-10 micrometers. These electrodes are held in place by bars such as 68 printed directly on a circuit board. The RF electrodes have a corresponding DC electrode. As shown the RF electrodes and their corresponding DC electrodes stack vertically from each other. The opposite RF/DC electrode pair also stack vertically but opposite the other pair.

The electrical connections are patterned into the substrate, forming at least a portion of the electrodes. Metallizing the whole structure using sputter coating and subsequent electroplating will create the electrical connections between the individual traces on the substrate and the corresponding electrodes. A hole 70 in the substrate allows sending lasers through the trap. If laser access from the side is desired, the support structures can be modified. To enhance structural stability, additional support structures can be added to the RF-electrodes. In addition, the DC-segments can be linked to each other while keeping them electrically isolated with a shadow mask as seen in the lower right diagram.

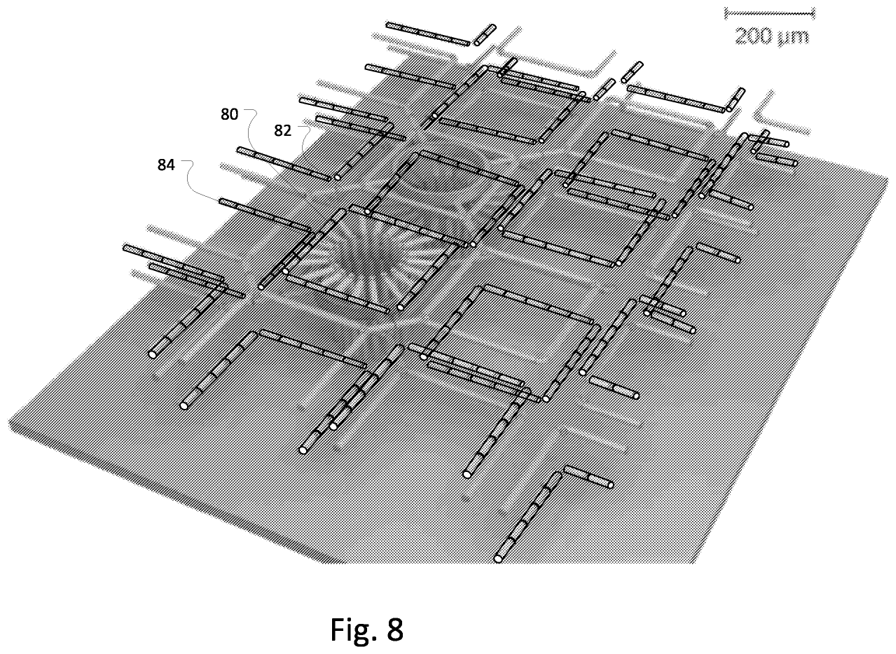

FIG. 8 shows a scalable ion-trap QIP-architecture based on 3D-printing. Each trapping zone consists of a linear trap with five DC-segments such as 80 each 30 μm. The RF electrodes such as 82 connect neighboring modules to allow for harmonic confinement in the junctions. Each cell 84 covers an area of 200 μm×200 μm allowing for 2,500 modules per cm². The whole structure can be printed on a substrate providing electrical connections. The substrate can be fabricated separately, potentially using CMOS technology, thereby integrating all filters and voltage sources and connecting them directly to the trap electrodes. Patterning the photoresist on the substrate with laser writing adds additional capabilities to route signals.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the embodiments.

1. A vertical ion trap, comprising:
at least four RF electrodes on a substrate, the RF electrodes extending up from the substrate;
a region between the electrodes forming the vertical ion trap; and
at least two direct current (DC) electrodes adjacent the RF electrodes and the vertical ion trap.

2. The vertical ion trap as claimed in claim 1, wherein the at least four RF electrodes comprises an array of electrodes on the substrate, and each region between sets of four electrodes form ion traps.

3. The vertical ion trap as claimed in claim 1, wherein the DC electrodes surround each of the RF electrodes.

4. The vertical ion trap as claimed in claim 1, wherein the at least four RF electrodes have a vertical extent of 100 microns and a width of 10 microns.

5. The ion trap as claimed in claim 1, further comprising traces on the substrate for each of the RF and DC electrodes, electrically isolated from each other electrode.

6. A horizontal ion trap, comprising:
a substrate, the substrate having a hole;
at least one RF electrode raised above the substrate and offset from any other RF electrodes across the hole; and
at least one direct current (DC) electrode corresponding to each RF electrode, the DC electrodes raised above the substrate.

7. The horizontal ion trap as claimed in claim 6, wherein the at least one RF electrode comprises at least two RF electrodes, wherein the two RF electrodes and their corresponding DC electrodes are offset vertically from each other.

8. The horizontal ion trap as claimed in claim 7, wherein a first RF electrode and corresponding DC electrode stack vertically from each other, and a second RF electrode and corresponding DC electrode stack vertically from each other but opposite from the first RF electrode and corresponding DC electrode.

9. The horizontal ion trap as claimed in claim 6, wherein the at least one RF electrode and the at least one DC electrode are raised off the substrate by bars printed directly on the substrate.

10. The horizontal ion trap as claimed in claim 9, further comprising electrical connections on the substrate connected to the bars.

11. The horizontal ion trap as claimed in claim 6, wherein the at least one RF electrode comprises a circular RF electrode suspended above the substrate and the at least one DC electrode comprises DC electrode segments offset from the RF electrodes, the RF electrodes and the DC electrode segments forming the ion trap.

12. The horizontal ion trap as claimed in claim 11, further comprising several RF electrodes connected to neighboring ion traps.

13. A method of forming an ion trap, comprising:
forming three-dimensional structures on a substrate in a curable polymer using two-photon polymerization direct laser writing;
metalizing the three-dimensional structures to form RF electrodes; and
forming direct current (DC) electrodes at least partially on the substrate.

14. The method as claimed in claim 13, wherein forming three-dimensional structures on a substrate comprises forming RF electrodes having a vertical extent from the substrate, creating a region between the electrodes that forms the ion trap.

15. The method as claimed in claim 13, wherein forming DC electrodes at least partially on the substrate comprises forming DC electrodes in-plane on the substrate surrounding the RF electrodes.

16. The method as claimed in claim 13, further comprising forming a hole in the substrate.

17. The method as claimed in claim 16, wherein forming three-dimensional structures comprises forming RF electrodes offset from each other across the hole.

18. The method as claimed in claim 17, wherein forming DC electrodes at least partially on the substrate comprises forming DC electrodes corresponding to the RF electrodes, each DC electrode offset vertically from the corresponding RF electrode.
